(19) United States
(12) Patent Application Publication
(10) Pub. No.: US 2007/0057918 A1
(43) Pub. Date: Mar. 15, 2007

(54) Mouse with extensible PS/2 mouse buttons

(76) Inventor: Yu-Bin Zhou, San Chung City (TW)

Correspondence Address: RABIN & Berdo, PC, 1101 14TH STREET, NW, SUITE 500, WASHINGTON, DC, 20005, US

(21) Appl. No.: 11/224,986

(22) Filed: Sep. 14, 2005

(51) Int. Cl. G09G 5/08

(52) U.S. Cl. 345/163

(57) ABSTRACT

A mouse with a plurality of buttons has a PS/2 driver as interface connected to a computer. A 4-bytes packet generated by the mouse is provided for the computer to analyze so as to update the display state of the mouse in the display and to perform specified function. This 4-bytes packet also has the 4th byte for controlling the movement of the mouse in vertical or horizontal scrolling direction and expanding the functions of the mouse. Therefore, it may not only greatly improve the convenience of control between the mouse and the computer, but also, comparing with the prior mouse, improve the expandability of many functions.

### BACKGROUND OF THE INVENTION

1. Field of Invention

The present invention relates to a mouse with a plurality of buttons, and particularly, to a PS/2 mouse with a plurality of buttons capable of generating a 4-bytes packet to a computer in order to control the movement of the mouse and perform specific functions.

2. Related Art

With development of the humanized software interfaces, the computer operation has entirely depended on the control of a mouse. Mouse is usually used to control the cursor displayed in the display. Every time a user moves the mouse, the computer will immediately receive the packet from the mouse. The related data about the mouse movement is recorded in the packet. Then, the computer will obtain the data of the mouse movement through analysis of the data in the packet, so as to redisplay the position of the cursor in the display. And data transmission between the computer and the mouse will be realized depending on the specific data transmission protocol.

The mouse can be classified into different types according to various methods, for example, mechanical mouse optmechanical mouse and optical mouse according to position principle of the mouse, and further infrared mouse or laser mouse according to different light sources; one button mouse early used on the Macintosh, commonly used 2 key mouse or 3 key mouse according to the keys on the mouse, and wheel mouse generated in accordance with the application of the internet ; and RS232 mouse, USB mouse, IrDA mouse and PS/2 mouse according to the transmission interface for the mouse.

The U.S. Pat. No. 5,838,304 discloses an old and known skill about assigning several buttons for an input device. However, It is only available for an input device with serial port, which is neither applied to a USB nor a PS/2 input device. In addition, it doesn't describe any skill about both the horizontal and vertical scrolling controls for an application on a display.

The predominated mouse in the market at present is the optical multi-keys wheel mouse with PS/2 interface. Due to its lightweight, small size, long service life, reasonable price and applicability in Internet, such mouse is favored by most of users. Other than enabling users to browse web pages directly by the wheel scrolling vertically, such mouse comprises multiple keys for setting different functions, so as to provide software design definition or allow users to do self-definition for performing a specific function. The execution of these functions is recorded in a packet and transmitted to the computer through a predefined data transmission protocol while the mouse transmits the packet.

However, along with the continuous renewal of the Internet application and computer software development in addition to relying on mouse increasingly, the existing data transmission protocol certainly can not satisfy the future application trend of mouse. Thus, it is essential to improve the existing data transmission protocol, and particularly to regulate a new data transmission protocol for popular PS/2 mouse, so as to develop the PS/2 mouse meeting the requirement of the future development and application.

### SUMMARY OF THE INVENTION

In view of the above problems, the main purpose of the invention is to provide a mouse with a plurality of buttons, which can transmit a 4-bytes packet to a computer so as to provide more convenience of mouse control and the expandability of functions.

To achieve the above objects, the mouse with a plurality of buttons disclosed in the invention comprises a plurality of buttons, which may generate a corresponding press signal in accordance with respective press state; a set of sensing devices for generating position information corresponding to the direction of X-Y axis, according to the current position state of the mouse; and a first encoding circuit for selectively receiving the press signal or the position information about the direction of X-Y axis, so as to code-generate a 4-bytes packet and then transmit it to a computer for processing. In the 4-bytes packet, each byte has 8 bits from 0th bit to the 7th bit, and the 4th byte comprises an H bit, a V bit and 6 bits (Z0˜Z5).

In a preferred embodiment of the invention, if the value of H bit is equal to that of V bit in the 4th byte (both of them are 0 or 1), the 6 bits (Z0˜Z5) are used to selectively provide the execution of the corresponding functions or the press state information of different buttons. And if the value of H bit is different from that of V bit (one is 0, and the other is 1), the H bit is responsible for providing the control information about the direction of vertical scrolling, while the V bit is responsible for providing the control information about the direction of horizontal scrolling, and the binary values of the 8 bits including an H bit, a V bit and Z0˜Z5 bits in the entire 4th byte are used to provide the position information about the directions of vertical and horizontal scrolling.

A second encoding circuit is further disclosed in a preferred embodiment of the invention. It may generate a 3-bytes packet providing the corresponding press signals of the different buttons and the position information about the direction of X-Y axis, and transmit it to a computer for processing, the 3-bytes packet.

As such, the user may transmit the preset switch command and ask the mouse to transmit a 4-bytes packet or 3-bytes packet through a PS/2 driver installed in the computer as required.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow for illustration only, and thus are not limitative of the present invention, and wherein:

FIG. 1 is a block diagram of the display connected to the computer and the mouse with a plurality of buttons according to the invention;

FIG. 2 is a schematic view of the preferred embodiment of a 4-bytes packet of the invention;

FIG. 3 is a schematic view of the mouse with a plurality of buttons of the invention; and

FIG. 4 is a flow chart of the operation modes switching of the mouse with a plurality of buttons of the invention.

### DETAILED DESCRIPTION OF THE INVENTION

At present, the mouse is the most important input apparatus for computer. For several common transmission interfaces of computer, the PS/2 mouse 20 is the most popular at present.

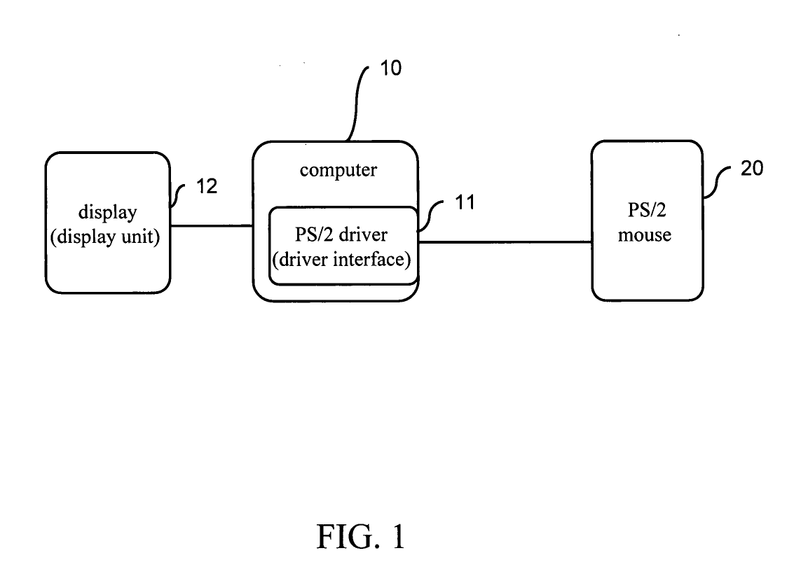

The block diagram of the operation of the PS/2 mouse 20 is shown in FIG. 1, in which a computer 10 is included with a PS/2 driver 11 installed in for communicating between the computer 10 and the mouse 20. Also, a display device 12 is connected to the computer 10 for displaying the cursor controlled by the PS/2 mouse 20. The PS/2 mouse 20 is connected to the computer 10 through the transmission line (PS/2 transmission line) so as to transmit packet data.

In practice, when the state of PS/2 mouse changes, including position movement, button pressing etc., the PS/2 mouse 20 will instantly generate a packet recording all data, and then transmit it to the computer 10 via the PS/2 driver 11 through the transmission line for processing. After receiving the packet, the computer 10 analyzes the packet and acquires the state changes of the PS/2 mouse 20, and the computer 10 further redisplays the corresponding changes or executes the corresponding functions, so as to allow other computer software of the computer 10 to execute the corresponding operation procedure.

In the past, the packets transmitted from the PS/2 mouse 20 are mainly 3-bytes packets, wherein each byte contains 8 bits (the 0th bit to the 7th bit, respectively). Each byte and bit is specified in the conventional PS/2 data transmission protocol as follows:

The 0th bit (L bit) of the first byte provides the press state information of the left button of the PS/2 mouse 20.

The 1st bit (R bit) of the first byte provides the press state information of the right button of the PS/2 mouse 20.

The 2nd bit (M bit) of the first byte provides press state information of the middle button of the PS/2 mouse 20.

The 3rd bit of the first byte is defined to be constant value 1.

The 4th bit (XS bit) of the first byte provides the state information of the sign bit of the PS/2 mouse 20 in the direction of the X axis.

The 5th bit (YS bit) of the first byte provides the state information of the sign bit of the PS/2 mouse 20 in the direction of the Y axis.

The 6th bit and the 7th bit of the first byte are defined to be constant value 0.

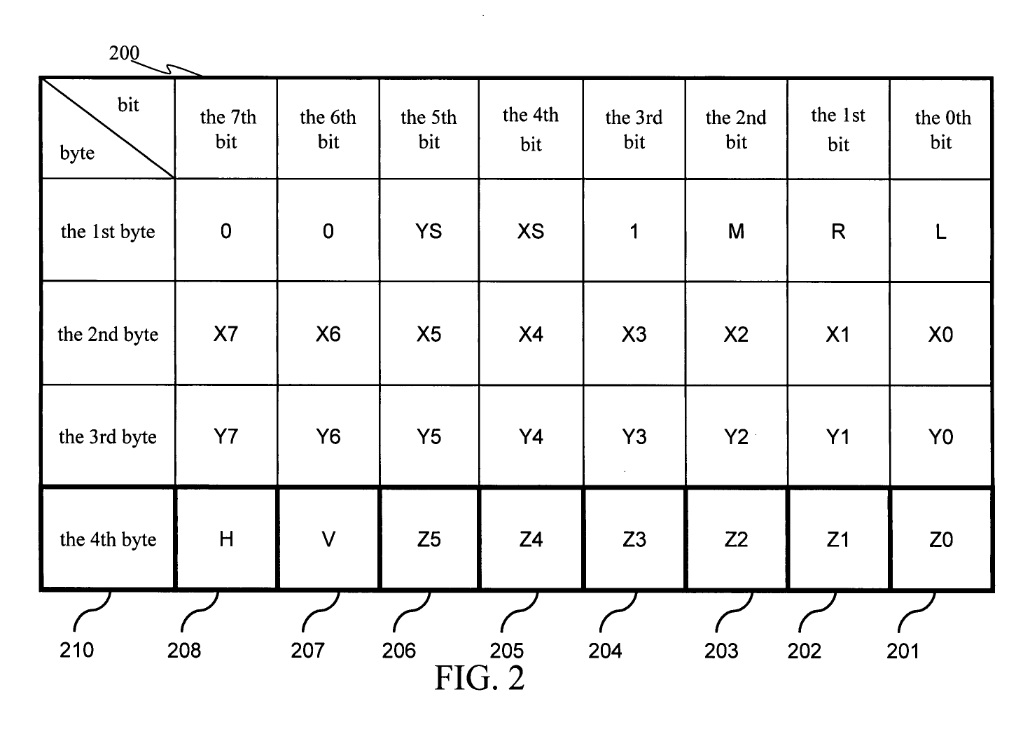

The 0th bit to the 7th bit of the second byte provide the position information of the PS/2 mouse 20 in the direction of the X axis, as X0 to X7 in FIG. 2.

The 0th bit to the 7th bit of the third byte provide the position information of the PS/2 mouse 20 in the direction of Y axis, as Y0 to Y7 in FIG. 2.

However, along with the continuous renewal of the Internet application and computer software development in addition to relying on mouse increasingly and the development of the design of PS/2 mouse 20, the specification of the existing PS/2 data transmission protocol possibly cannot be used in the future. Therefore, the present invention particularly provides a 4-bytes packet 200 (as shown in FIG. 2) to replace the 3-bytes packet generated by the existing PS/2 mouse 20, thereby providing a new PS/2 mouse 20.

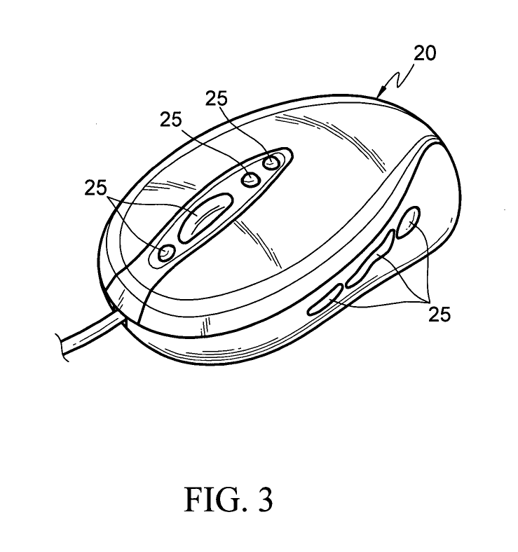

In a preferred embodiment, the PS/2 mouse 20 of the invention as shown in FIG. 3 comprises:

(1) a plurality of buttons 25 for generate a corresponding press signal to be transmitted to the first encoding circuit, according to the press state of each button.

(2) sensing devices (not shown) for generating the position information corresponding to the direction of the X-Y axis for the first encoding circuit, according to the current position state of the PS/2 mouse 20.

(3) the first encoding circuit (not shown) for selectively receiving the press signal or the position information about the direction of the X-Y axis, so as to code-generate a 4-bytes packet 200, and then transmit it to the computer 10 for processing.

As shown in FIG. 2, the 4-bytes packet 200 is characterized in that each byte has 8 bits from the 0th bit to the 7th bit, and the 4th byte 210 comprises 6 bits Z0˜Z5 (201˜206), a V bit 207 and an H bit 208. As the value of the H bit 208 is equal to that of the V bit 207 (both are 1 or 0), 6 bits Z0˜Z5 (201˜206) is used to selectively provide the execution of the corresponding functions, or to provide the press state information of different buttons; and as the value of the H bit 208 is different from that of the V bit 207 (wherein one is 1, and the other is 0), the H bit 208 is responsible for providing the control information about the direction of vertical scrolling, and the V bit 207 is responsible for providing the control information about the direction of the horizontal direction. In such case, the binary values of 8 bits including the H bit 208, the V bit 207 and the 6 bits Z0˜Z5 (201˜206) are used to provide the control information about the directions of vertical or horizontal scrolling. The other three previous bytes that are, the 1st byte, the 2nd bite, and the 3rd byte) is entirely the same as the content of the conventional technology, which will not be described here in details.

While in the preferred embodiment, the H bit 208 and the V bit 207 is defined to locate in the 7th bit and the 6th bit of the 4th byte 210, respectively, and the 0th bit to the 5th bit are the bits Z0˜Z5 (201˜206), respectively. But in practical design, the aspect of this preferred embodiment is not to be regarded as limitation, which will be explained as follows.

There are two situations that the H bit 208 is equal to the V bit 207:

(1) as the H bit 208 and the V bit 207 are 1 at the same time, the 5 bits Z0˜Z4 (201˜205) are defined to provide the execution of the corresponding functions, while the bit Z5 206 is used to provide the execution of the specific function.

(2) as the H bit 208 and the V bit 207 are 0 at the same time, the 4 bits Z0˜Z3 (201˜204) are defined to provide the execution of the corresponding functions, while the Z4 bit 205 and the Z5 bit 206 are used to provide the press state information of different buttons.

There are also two situations that the H bit 208 is different from the V bit 207:

(1) as the H bit 208 is 1 and the V bit 207 is 0, the position information about the directions of vertical and horizontal scrolling represented by the H bit 208, the V bit 207and the 6 bits Z0˜Z5 (201˜206) may indicates the position information of the PS/2 mouse 20 in the direction of vertical scrolling.

(2) as the H bit 208 is 0 and the V bit 207 is 1, the position information of the directions of vertical and horizontal scrolling indicated by the H bit 208, the V bit 207and the 6 bits Z0˜Z5 (201˜206) may indicate the position information of the PS/2 mouse 20 in the direction of horizontal scrolling.

In order to provide the PS/2 mouse 20 of the invention with the backward compatibility of the prior 3-bytes data transmission protocol, a PS/2 mouse 20 is further provided in the preferred embodiment to generate a conventional 3-bytes packet through the second encoding circuit and transmit it to the computer for processing. The conventional 3-bytes packet may be used to control the press state of different buttons, and simply control the position information about the direction of the X-Y axis. In fact, for practical realization of the circuit, the first encoding circuit and the second encoding circuit also may be integrated to be a single encoding circuit.

The PS/2 mouse 20 can be switched between two operation modes through switching at will, for example, a set of preset switch commands are preset in the PS/2 driver 11, and then, when the commands is transmitted by a user to the PS/2 mouse 20 through the PS/2 driver 11, the PS/2 mouse 20 will reply to confirm the switch, thereby completing the procedure of switching between the operation modes.

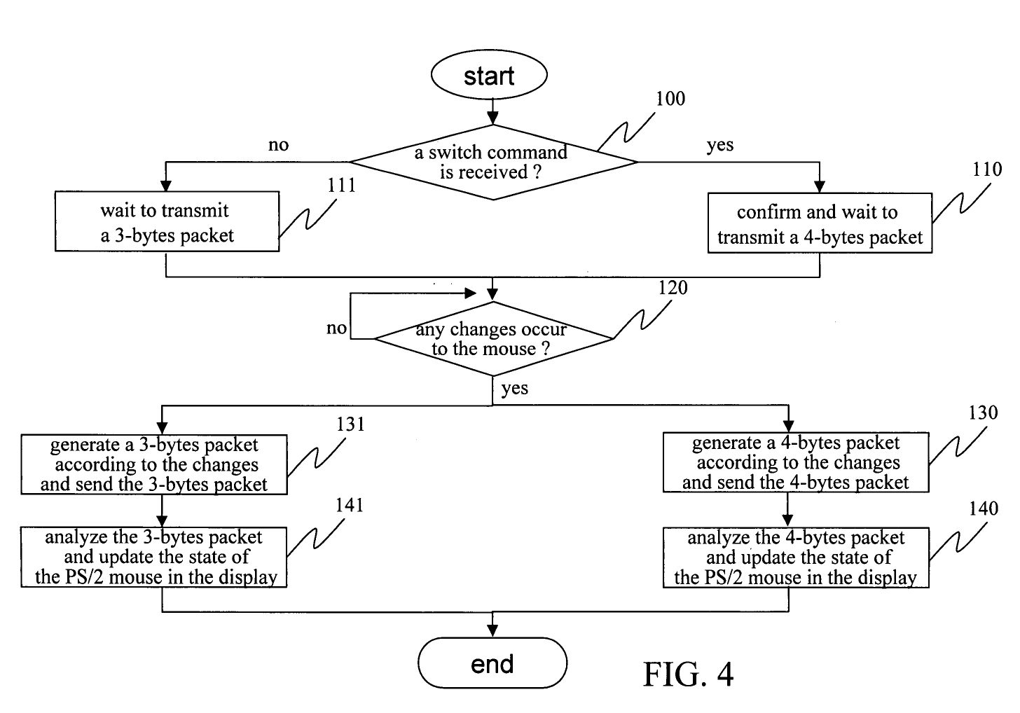

The whole flow of switching between operation modes of the PS/2 mouse 20 of the invention may be simply described through FIG. 4. Assuming that the preset operation mode of the PS/2 mouse 20 is to transmit a 3-bytes packet, and the PS/2 mouse 20 in operation will determine whether a switch command is received (step 100). If a correct preset switch command is received, proceed to step 110 to reply confirmation and wait to transmit a 4-bytes packet 210 when the state of PS/2 mouse 20 changes. Otherwise, if a preset switch command is not received, keep on waiting to transmit a 3-bytes packet (step 111).

In any operation mode, the PS/2 mouse 20 will determine whether any new changes occur (step 120) (moving PS/2 mouse or pressing buttons by a user etc.). When any changes occur to the PS/2 mouse 20, if it is switched to the state of transmitting a 4-bytes packet 200 at that time, a corresponding 4-bytes packet 200 is generated according to the changed state and transmitted to the computer 10 (step 130). After receiving the 4-bytes packet 200, the computer 10 starts to analyze, and then updates the state of the PS/2 mouse 20 according to the changed content (step 140). On the contrary, if the PS/2 mouse 20 is in the state of transmitting a 3-bytes packet at that time, a corresponding 3-bytes packet is generated according to the changed state and transmitted to the computer 10 (step 131). After receiving the 3-bytes packet, the computer 10 starts to analyze and then updates the state of the PS/2 mouse 20 according to the changed content (step 141).

Therefore, according to the present invention, not only the convenience of control of the PS/2 mouse 20 can be greatly improved, but also the expandability of many functions can be provided, thus it has practical utility value in the industry.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A mouse with a plurality of buttons, at least comprising:
a PS/2 driver transmitting data to a computer; and
a first encoding circuit for generating a 4-bytes packet by encoding;
wherein each byte has 8 bits from 0th bit to 7th bit, and corresponds to the plurality of buttons;
wherein the 8 bits in the 4th byte including:
a H bit, a V bit, and 6 bits Z0˜Z5;
wherein if the value of H bit is equal to that of V bit, then the 6 bits Z0˜Z5 may produce a corresponding press signal and perform a corresponding function, respectively;
wherein if the value of H bit is different from that of V bit; the H bit is responsible for providing the control information about the direction of vertical scrolling of the mouse; the V bit is responsible for providing the control information about the direction of horizontal scrolling of the mouse; and the H bit, V bit and 6 bits Z0˜Z5 are used to provide the control information about vertical or horizontal scrolling of the mouse.

2. The mouse of claims 1, wherein the H bit and V bit are located in the 7th bit and the 6th bit of the 4th byte respectively, and the 0th bit to the 5th bit are the bits Z0 to Z5 respectively.

3. The mouse of claims 1, wherein as both value of the H bit and V bit are 1, the 5 bits Z0 to Z4 are used to provide the execution of the corresponding functions and the bit Z5 is used to provide the execution of the specific function.

4. The mouse of claims 1, wherein as both value of the H bit and V bit are 0, the 4 bits Z0 to Z3 are used to provide the execution of the corresponding functions, and the Z4 and Z5 bits are used to provide the press state information of different specified buttons.

5. The mouse of claims 1, wherein as the value of the H bit is 1 and the value of the V bit is 0, the control information about vertical or horizontal scrolling of the mouse included in the H bit, V bit and 6 bits Z0 to Z5 is used to provide the position information about the direction of the vertical scrolling.

6. The mouse of claims 1, wherein as the value of the H bit is 0 and the value of the V bit is 1, the control information about vertical or horizontal scrolling of the mouse included in the H bit, V bit and 6 bits Z0 to Z5 is used to provide the position information about the direction of the horizontal scrolling.

7. The mouse of claims 1, wherein the mouse further comprises a second encoding circuit to generate a 3-bytes packet by encoding.

8. The mouse of claims 1, wherein the first encoding circuit and the second encoding circuit may be switched through a preset switch command transmitted by the PS/2 driver.

9. A method of extending a plurality of buttons for a PS/2 mouse, comprising:
providing a PS/2 driver transmitting data to a computer; and
providing a first encoding circuit for generating a 4-bytes packet by encoding;
wherein each byte has 8 bits from 0th bit to 7th bit, and corresponds to the plurality of buttons;
wherein the 8 bits in the 4th byte including:
a H bit, a V bit, and 6 bits Z0˜Z5;
if the value of H bit is equal to that of V bit, then the 6 bits Z0˜Z5 may produce a corresponding press signal and perform a corresponding function, respectively;
if the value of H bit is different from that of V bit; the H bit is responsible for providing the control information about the direction of vertical scrolling of the mouse; the V bit is responsible for providing the control information about the direction of horizontal scrolling of the mouse; and the H bit, V bit and 6 bits Z0˜Z5 are used to provide the control information about vertical or horizontal scrolling of the mouse.
